(19) United States
(12) Patent Application Publication
(10) Pub. No.: US 2018/0165662 A1
(43) Pub. Date: Jun. 14, 2018

(54) CUSTOMIZED FINANCIAL PROCESSING SYSTEM USING SUB-AUTHENTICATION, AND METHOD THEREFOR

(71) Applicant: Ki-won NAM, Seoul (KR)

(72) Inventor: Ki-won NAM, Seoul (KR)

(21) Appl. No.: 15/578,819

(22) PCT Filed: Jun. 2, 2016
(86) PCT No.: PCT/KR2016/005830

§ 371 Date: Dec. 1, 2017

(30) Foreign Application Priority Data
Jun. 2, 2015 (KR) 10-2015-0077832

(51) Int. Cl. G06Q 20/10; G06Q 20/40; G06Q 20/42; G06Q 20/32; G06Q 40/02; H04L 9/32

(52) U.S. Cl. CPC G06Q 20/10; G06Q 20/40145; G06Q 20/42; H04L 9/3263; G06Q 40/02; H04L 9/3231; G06Q 20/32

(57) ABSTRACT

The present invention relates to a customized financial processing system using sub-authentication and a method therefore, and to a customized financial processing system and a method using sub-authentication, in which authentication information for a recipient is pre-registered, remittance is performed after verifying authenticity of the recipient when requesting remittance, and if an acquaintance of a remitter is additionally registered as a sub-authenticator, the remittance is performed when approval by the acquaintance is granted and at the same time, the recipient authentication is performed, in addition, a grade based on account establishment information and use information of a recipient is assigned in advance, such that authentication is performed through different authentication items for each grade, thereby making complex additional authentication to be performed for an account with a low grade that is probably a fake deposit.

### TECHNICAL FIELD

The present invention relates to a customized financial processing system using sub-authentication and a method therefore, and more particularly, to a customized financial processing system and a method using sub-authentication, in which authentication information for a recipient is pre-registered, remittance is performed after verifying authenticity of the recipient when requesting remittance, and if an acquaintance of a remitter is additionally registered as a sub-authenticator, the remittance is performed when approval by the acquaintance is granted and at the same time, the recipient authentication is performed.

### BACKGROUND ART

As well-known, recently, information communication techniques have been rapidly developed, and inter alia, high speed data transmission techniques for transmitting massive data with mobile communication as the center have been rapidly developed.

Accordingly, a significant percentage of various financial transactions are made through a desktop PC or a mobile device. In this case, since the financial transactions are made without face-to-face contact, various financial frauds such as voice phishing, SMS phishing, or the like are frequently committed in recent years, which causes a great damage.

The voice phishing is financial fraud committed by a method of inducing financial transactions or stealing private financial information by impersonating personnel of a prosecution, the financial supervisory service, a court, a financial institution, or the like. Similarly, the SMS phishing is also fraud committed by a method of inducing financial transactions or stealing private financial information using a long fraudulent text by impersonating personnel of a public institution.

Since a user cannot check whether a phone number of a caller is actually a phone number of a public institution within a short time during which phone call is made, the user may suffer from the voice phishing, or even in a case in which a public institution actually makes a call for inquiry, people doubt without any cause, such that work of the public institution may be interfered.

Further, in the case of SMS phishing, since a phone number of a sender may be arbitrarily changed by the sender, there is no way to check whether the sender is a public institution by checking the phone number.

To solve such problems, techniques such as Korean Patent Application No. 10-2013-90478 for verifying validity of a call or an SMS by checking whether the caller or a sender is a real public institution by verifying a phone number of the call or the SMS to a mobile phone of a user have been introduced.

The above-described techniques are effective to a certain extent, but a system actually operated in a financial institution at present has a fundamental problem that there is no procedure for verifying a recipient at the time of remittance.

In particular, in a case of elderly people vulnerable to online financial fraud such as voice phishing or pharming, if monitoring on remittance or payment from an account owned by an elderly person is performed, it may be possible to significantly decrease the financial fraud. However, for the lack of time or economic reasons, it is nearly impossible to perform the monitoring by the financial institution or financial supervisory institution.

### DISCLOSURE

### Technical Problem

In consideration of the above-mentioned circumstances, it is an object of the present invention to provide a customized financial processing system and a method using sub-authentication, in which authentication information for a recipient is pre-registered, remittance is performed after verifying authenticity of the recipient when requesting remittance, and if an acquaintance of a remitter is additionally registered as a sub-authenticator, the remittance is performed when approval by the acquaintance is granted and at the same time, the recipient authentication is performed.

Another object of the present invention is to provide a customized financial processing system and a method using sub-authentication in which a grade based on account establishment information and use information of a recipient is assigned in advance, such that authentication is performed through different authentication items for each grade, thereby making complex additional authentication to be performed for an account with a low grade that is probably a fake deposit.

### Technical Solution

In an order to accomplish the above-described objects, according to an aspect of the present invention, there is provided a customized financial processing method including: a) receiving, by a sub-authentication processing server 8, authentication information from a sub-authenticator terminal 2B and registering the authentication information; b) receiving, by a financial server 6, authentication information and a financial processing request signal from a main authenticator terminal 2A; c) transmitting, by the financial server 6, the sub-authentication information to the sub-authentication processing server 8; d) transmitting, by the sub-authentication processing server 8, an authentication request signal to the sub-authenticator terminal 2B; e) receiving, by the sub-authentication terminal 2B, authentication information that is applied; f) transmitting, by the sub-authenticator terminal 2B, the authentication information to the sub-authentication processing server 8; g) performing, by the sub-authentication processing server 8, authentication processing; h) transmitting, by the sub-authentication processing server 8, authentication result information to the financial server 6; and i) performing, by the financial server 6, financial processing requested by the main authenticator.

Preferably, the financial processing request signal in the receiving b) includes information on remittance to a specific sub-authenticator.

Preferably, the financial processing request signal in the receiving b) includes information on remittance to a specific recipient, and the customized financial processing method further includes extracting, by the financial server 6, sub-authenticator information for requesting an approval signal for remittance to the recipient to the sub-authenticator connected to the main authenticator.

Preferably, the customized financial processing method further includes: in the transmitting c), if the financial processing request signal is for remittance, and the sub-authenticator information extracted by the financial server 6 is information of an acquaintance of the main authenticator, requesting an approval signal of the acquaintance for the remittance, and requesting the sub-authentication processing of the recipient who is an object of the remittance to the sub-authentication processing server 8.

Preferably, the customized financial processing method further includes: in the transmitting c), if the financial processing request signal is for card payment, and the sub-authenticator information extracted by the financial server 6 is information of an acquaintance of the main authenticator, requesting an approval signal of the acquaintance for the card payment, and requesting the sub-authentication processing of a seller who is an object of performing the card payment to the sub-authentication processing server 8.

Preferably, the customized financial processing method further includes: between the receiving b) and the transmitting d), transferring, by the sub-authentication processing server 8, a remittance amount to a recipient temporary account and making the remittance amount to be on standby, in a case of remittance.

Preferably, the customized financial processing method further includes: between the receiving b) and the transmitting d), transferring, by the sub-authentication processing server 8, a payment amount to a seller temporary account and making the payment amount to be on standby, in a case of card payment.

Preferably, the authentication processing in the performing g) comprises determining whether the recipient is a recipient pre-registered in the sub-authentication processing server 8.

Preferably, the authentication processing in the performing g) comprises determining whether the seller is a seller pre-registered in the sub-authentication processing server 8.

Preferably, the authentication processing in the performing g) comprises: receiving, by the sub-authentication processing server 8, an approval signal of the sub-authenticator for remittance or payment which is wanted to be processed by the main authenticator; and verifying authenticity of the sub-authenticator.

Preferably, the customized financial processing method further includes: before the performing g), assigning, by the sub-authentication processing server 8, a grade of the sub-authenticator; and in the performing g), performing, by the sub-authentication processing server 8, the authentication for an authentication item matched with each grade of the sub-authenticator.

Preferably, the authentication processing in the performing g) further comprises transmitting, by an external institution, the sub-authenticator information to an electronic government (e-government) server, a national police agency server, or a national health insurance service server to perform authentication processing.

Preferably, the authentication processing in the performing g) comprises generating a signal for pre-authentication of the sub-authenticator terminal 2B for the sub-authentication processing server 8 in advance and registering the signal.

Preferably, the authentication processing in the performing g) comprises generating a signal for post-authentication of the sub-authenticator terminal 2B for the sub-authentication processing server 8 and registering the signal.

Preferably, the customized financial processing method further includes: assigning, by the sub-authentication processing server 8, a grade in an order from the oldest recipient account establishment date and in an order from the highest transaction frequency.

According to another aspect of the present invention, there is provided a customized financial processing system using sub-authentication, including: a main authenticator terminal 2A configured to generate, to a financial server 6, a signal for requesting a financial account of a main authenticator to perform transfer or payment of a certain amount of money, receive information on a sub-authentication processing state in response to the request signal, and output the information on a screen; a sub-authenticator terminal 2B in which a financial information processing application 4 for inputting sub-authentication information by receiving a sub-authentication request signal from a sub-authentication processing server 8 in response to the signal for requesting the financial account of the main authenticator to perform transfer or payment of the certain amount of money is installed; the financial server 6 configured to pre-register authentication information of the main authenticator, determine whether sub-authentication is normally processed by interworking with the sub-authentication processing server 8 when a request signal for a specific financial processing is received from the main authenticator terminal 2A, and perform the financial processing requested by the main authenticator; and the sub-authentication processing server 8 configured to pre-register authentication information of the sub-authenticator, transmit the sub-authentication request signal to the sub-authenticator terminal 2B when receiving the sub-authentication request signal from the financial server 6, perform sub-authentication processing in response to the sub-authentication request signal, and transmit information on a result of the sub-authentication processing to the financial server 6.

Preferably, the main authenticator is an account owner.

Preferably, the sub-authenticator is a recipient.

Preferably, the financial server 6 comprises a database including the recipient temporary account 10 in which the remittance amount to be remitted to the recipient at the time of completing the authentication of the main authenticator is on standby, and a recipient real account 12 to which the remittance amount to be remitted to the recipient at the time of completing the authentication of the sub-authenticator is remitted, which are dividedly constructed therein.

Preferably, the sub-authentication processing server is constructed in the financial server 6 while being separately divided.

Preferably, the financial information processing application 4 installed in the sub-authenticator terminal 2B interworks with an authentication tool configured to operate a fingerprint sensor for scanning fingerprints or a camera for photographing an image of the sub-authenticator.

Preferably, the sub-authentication processing server 8 performs sub-authentication by interworking with an e-government in which a fingerprint image or a facial image of the sub-authenticator is pre-registered.

Preferably, the sub-authentication processing server performs sub-authentication by interworking with a national health insurance service server managing a medical insurance maintaining state of the sub-authenticator.

Preferably, the financial information processing application 4 includes: an authentication information input unit 36 configured to input information such as a password, a pattern image, an authenticated certificate, or a mobile phone authentication number, or input authentication information such as a fingerprint image or a facial image; an authentication interworking tool controller 40 configured to control an operation of an authentication interworking tool including a fingerprint sensor for scanning fingerprints or a camera for photographing an image of the sub-authenticator; an automatic data packet generator 38 configured to generate a single data packet including authentication information, an application identification number, and terminal identification information; a data transmitter 42 configured to automatically transmit the data packet generated in the automatic data packet generator 38 to the sub-authentication processing server 8; and a controller 44 configured to receive sub-authentication request information from the sub-authentication processing server 8, and perform a control to input and transmit sub-authentication information.

Preferably, the sub-authentication processing server 8 comprises a database including information of a recipient temporary account 10 constructed therein, in which a remittance amount to be remitted to a recipient is on standby until authentication of the main authenticator is completed.

Preferably, the sub-authentication processing server further comprises: an authentication information registration unit 48 configured to register authentication information of the sub-authenticator; an authentication request signal generator 50 configured to generate an authentication request signal to the sub-authenticator terminal 2B; an authentication processor 52 configured to compare the authentication information pre-registered in the authentication information registration unit 48 with authentication information transmitted from the sub-authenticator terminal 2B to perform authentication processing; a data transmitter 54 configured to transmit results of the authentication processed in the authentication processor 52 to the financial server 6; and a controller 64 configured to receive an authentication request signal for a specific sub-authenticator from the financial server 6 and perform a control to perform authentication processing for the sub-authenticator.

Preferably, the sub-authentication processing server 8 further comprises a temporary account manager 60 in which a remittance amount to be remitted to the recipient at the time of completing the authentication of the main authenticator is on standby.

Preferably, the sub-authentication processing server 8 further includes an external institution authentication request unit 62 configured to transmit sub-authenticator information to the e-government server, a national police agency server, or a national health insurance service server to perform authentication processing.

Preferably, the sub-authenticator is divided into a first sub-authenticator connected together with the main authenticator when requesting remittance of the main authenticator, and a second sub-authenticator who is a recipient for receiving a remittance amount from the main authenticator, and remittance processing is performed when authentications of the first and second sub-authenticators succeed.

Preferably, wherein in a case in which a money manager is set as the main authenticator, the sub-authentication processing server 8 allows receipt confirmation to be performed only by the authentication of the main authenticator, and limits remittance or withdrawal to be performed only when authentication of the sub-authenticator who is an account owner additionally succeeds.

Preferably, the sub-authentication processing server 8 assigns a recipient grade based on establishment and a state of a recipient account, and makes different authentication processes to be performed for each recipient grade.

Preferably, the sub-authentication processing server 8 further includes: an authentication grade manager 56 configured to assign and manage a recipient grade based on establishment and a state of a recipient account; and a grade-based authentication processing item manager 58 configured to manage authentication processing items for each recipient grade.

Preferably, the sub-authentication processing server comprises an authentication item table 66 constructed therein, which includes authentication items to be processed for each recipient grade assigned in advance based on establishment and a state of a recipient account.

Preferably, the sub-authentication processing server is configured to assign a grade in an order from the oldest recipient account establishment date and in an order from the highest transaction frequency.

Preferably, the sub-authenticator is a main authenticator' acquaintance who is connected together with a main authenticator when requesting remittance of the main authenticator.

Preferably, when authentication is requested by the financial server 6 receiving a signal for requesting payment of a predetermined amount to a credit card account or a debit card account of the main authenticator from the main authenticator terminal 2A, the sub-authentication processing server 8 is configured to transmit payment information to a pre-registered sub-authenticator terminal 2B, and request authentication information for approving the card payment, and the financial server 6 is configured to make the payment information to be on standby in a temporary account 14 of a seller until the authentication is completed.

Preferably, in the sub-authenticator terminal 2B receiving a request for a payment approval signal from the sub-authentication processing server 8, temporary payment information and a call button 30 for a call with the main authenticator is further output on a screen of the financial information processing application 4.

Preferably, the authentication item table 66 includes pre-registered authentication items according to a grade of the sub-authenticator among items classified in an order of mobile phone pattern authentication; account password authentication; authentication through a mobile phone authentication number; authentication through an authenticated certificate; biometric authentication through fingerprints, irises, genes, and facial recognition; and external institution authentication through an e-government, a national police agency, or a national health insurance service.

### Advantageous Effects

In accordance with the customized financial processing system and the method using sub-authentication according to the present invention, remittance is performed at the time of completing the recipient authentication, and if an acquaintance of a remitter is additionally registered as a sub-authenticator, the remittance is performed when approval by the acquaintance is granted and at the same time, the recipient authentication is performed, such that it is possible to perform customized monitoring on an account that is probably a fake deposit. Even in the case of card payment, payment is made after seller authentication and approval of an additionally registered acquaintance, such that safe credit transaction can be made. Further, a grade based on account establishment information and use information of a recipient is assigned in advance, such that the authentication is performed through different authentication items for each grade. As a result, an account with a low grade that is probably a fake deposit is hard to make transactions, thereby implementing safe financial transactions.

### DESCRIPTION OF DRAWINGS

FIG. 1 is a diagram illustrating a schematic configuration of a customized financial processing system using sub-authentication according to a first embodiment of the present invention.

FIG. 2 is a flow chart illustrating a data flow of the customized financial processing system using sub-authentication according to the first embodiment of the present invention.

FIG. 3 is a diagram illustrating a screen displayed on a sub-authenticator terminal through the customized financial processing system using sub-authentication according to the first embodiment of the present invention.

FIG. 4A is a diagram illustrating a state of processing a plurality of sub-authentications through the customized financial processing system using sub-authentication according to the first embodiment of the present invention.

FIG. 4B is a diagram illustrating a state of processing sub-authentication that is limitedly performed for a withdrawal through the customized financial processing system using sub-authentication according to the first embodiment of the present invention.

FIG. 5 is a diagram illustrating an additionally designated sub-authentication screen in a remittance step through the customized financial processing system using sub-authentication according to the first embodiment of the present invention.

FIG. 6 is a block diagram illustrating a configuration of a financial information processing application included in the customized financial processing system using sub-authentication according to the first embodiment of the present invention and installed in an authenticator terminal.

FIG. 7 is a block diagram illustrating a configuration of a sub-authentication processing server included in the customized financial processing system using sub-authentication according to the first embodiment of the present invention.

FIG. 8 is an authentication item table illustrating authentication items for each grade through the customized financial processing system using sub-authentication according to the first embodiment of the present invention.

FIG. 9 is a flow chart illustrating that sub-authentication is performed at the time of payment through a customized financial processing system using sub-authentication according to a second embodiment of the present invention.

FIG. 10 is a diagram illustrating a screen displayed on a sub-authenticator terminal through the customized financial processing system using sub-authentication according to the second embodiment of the present invention.

### BEST MODE

Hereinafter, a first embodiment of the present invention will be described in detail with reference to the drawings.

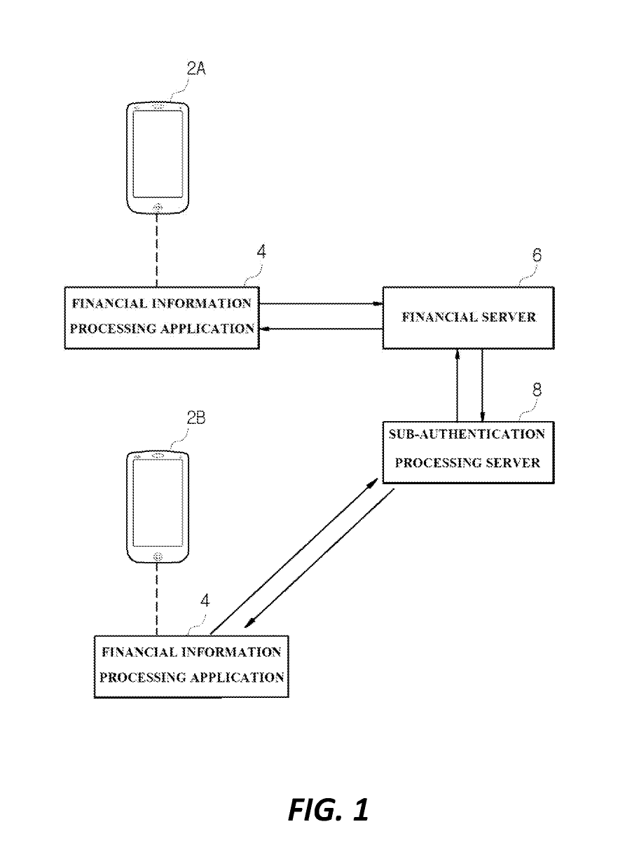

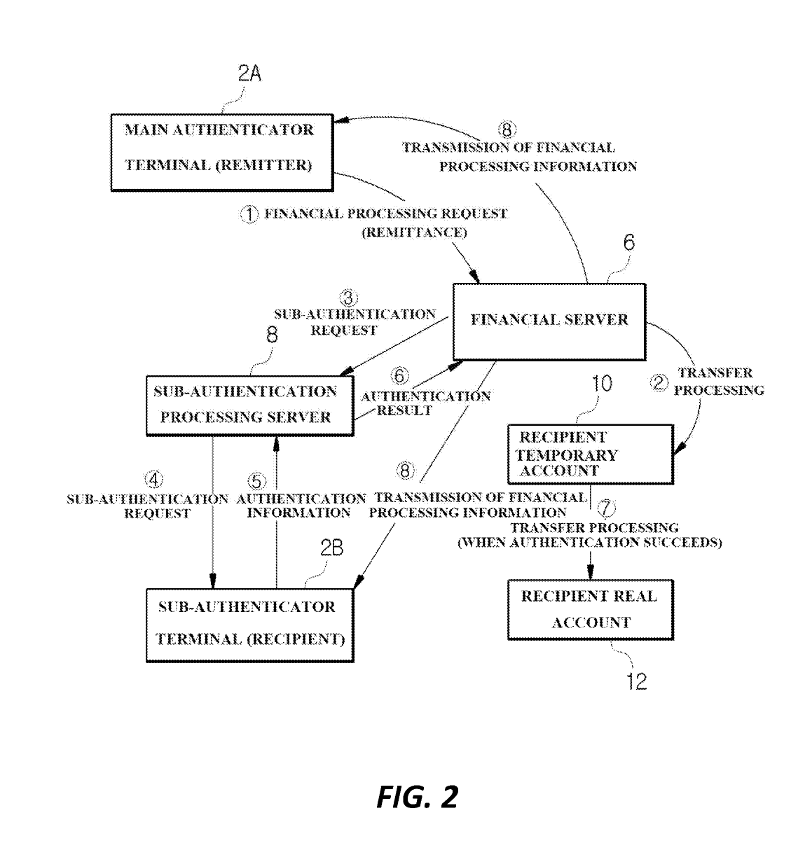

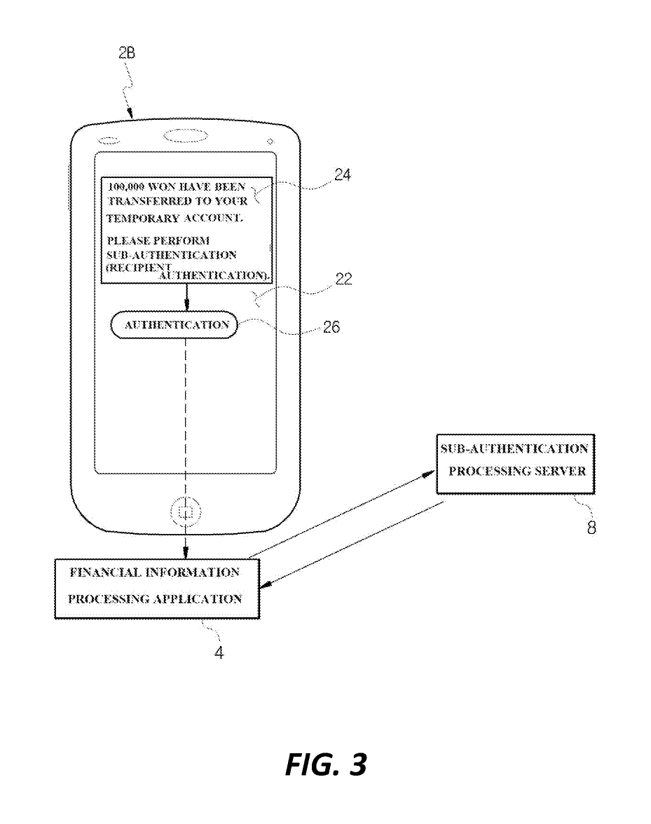

FIG. 1 is a diagram illustrating a schematic configuration of a customized financial processing system using sub-authentication according to a first embodiment of the present invention, FIG. 2 is a flow chart illustrating a data flow of the customized financial processing system using sub-authentication according to the first embodiment of the present invention, and FIG. 3 is a diagram illustrating a screen displayed on a sub-authenticator terminal through the customized financial processing system using sub-authentication according to the first embodiment of the present invention.

Referring to FIGS. 1 to 3, the customized financial processing system using sub-authentication according to the first embodiment of the present invention is a customized financial processing system using sub-authentication, in which authentication information for a recipient is pre-registered, remittance is performed after verifying authenticity of the recipient when requesting remittance, and if an acquaintance of a remitter is additionally registered as a sub-authenticator, the remittance is performed when approval by the acquaintance is granted and at the same time, the recipient authentication is performed.

More specifically, the customized financial processing system using sub-authentication according to the first embodiment of the present invention is a system on the basis that recipient authentication is further performed in addition to remitter authentication to block remittance to an account such as a fake deposit, unlike a conventional system in which authentication only for a remitter is performed.

To this end, the customized financial processing system using sub-authentication according to the first embodiment of the present invention includes a main authenticator terminal 2A that generates, to a financial server 6, a signal for requesting a financial account of a main authenticator to perform transfer or payment of a certain amount of money, receives information on a sub-authentication processing state in response to the request signal, and outputs the information on a screen; and a sub-authenticator terminal 2B in which a financial information processing application 4 for inputting sub-authentication information by receiving a sub-authentication request signal from a sub-authentication processing server 8 in response to the signal for requesting the financial account of the main authenticator to perform transfer or payment of the certain amount of money is installed.

Further, the customized financial processing system using sub-authentication according to the first embodiment of the present invention includes the financial server 6 that pre-registers authentication information of the main authenticator, determines whether sub-authentication is normally processed by interworking with the sub-authentication processing server 8 when a request signal for a specific financial processing is received from the main authenticator terminal 2A, and performs financial processing requested by the main authenticator; and the sub-authentication processing server 8 that pre-registers the authentication information of the sub-authenticator, transmits a sub-authentication request signal to the sub-authenticator terminal 2B when receiving the sub-authentication request signal from the financial server 6, performs sub-authentication processing in response to the sub-authentication request signal, and transmits information on a result of the sub-authentication processing to the financial server 6.

At this time, the main authenticator is an account owner, and the sub authenticator is a recipient.

Further, the sub-authentication is to verify whether the sub-authenticator is a correct recipient. The sub-authentication processing server 8 may perform authentication for the sub-authenticator through various authentication means.

The main authenticator authenticates himself/herself to the financial server 6 and requests remittance. At the time of request of the remittance, a remittance amount is transferred to a temporary account in a remittance standby state, and when the authentication of the sub-authenticator is completed, the remittance amount is transferred to a real account of the recipient.

Accordingly, the financial server 6 comprises a database (not illustrated) including a recipient temporary account 10 in which a remittance amount to be remitted to the recipient at the time of completing the authentication of the main authenticator is on standby, and a recipient real account 12 to which the remittance amount to be remitted to the recipient at the time of completing the authentication of the sub-authenticator is remitted, which are dividedly constructed therein.

Herein, the recipient temporary account 10 means an account from which the recipient may not arbitrarily transfer or withdraw money, and the recipient real account means an account from which the recipient may arbitrarily transfer or withdraw money.

Meanwhile, the sub-authentication processing server 8 may be constructed in the same location as the financial server 6, that is, in a server room of the same financial institution. Alternately, the sub-authentication processing server 8 may also be constructed in the financial server 6 with being separately divided.

Further, the sub-authenticator terminal 2B receives authentication information for verifying authenticity of the sub-authenticator, and may also perform authentication through fingerprints or facial image analysis. Accordingly, the financial information processing application 4 installed in the sub-authenticator terminal 2B interworks with an authentication tool configured to operate a fingerprint sensor for scanning fingerprints or a camera for photographing an image of the sub-authenticator.

More preferably, the sub-authentication processing server 8 may perform sub-authentication by interworking with an electronic government (e-government) server in which a fingerprint image or a facial image of the sub-authenticator is pre-registered.

That is, in the e-government server (not illustrated), scanned fingerprint images and picture information of all people having an issued identification card are stored. Thus, the sub-authentication processing server 8 may determine authenticity of the sub-authenticator through fingerprint authentication or facial image authentication by interworking with the e-government server.

Further, the sub-authentication processing server 8 may perform sub-authentication by interworking with a national health insurance service server managing a medical insurance maintaining state of the sub-authenticator. Similar to using information stored in the e-government server, the nation health insurance service manages information of most of the people on whether an economic activity is continued such as insurance premium payment history, thus the sub-authentication processing server 8 may determine whether there is a possibility that the sub-authenticator is an owner of a fake deposit by interworking with the national health insurance service server (not illustrated).

The customized financial processing system using sub-authentication according to the first embodiment of the present invention configured as described above performs a step in which the sub-authenticator registers his/her authentication information in the sub-authentication processing server 8. At this time, for the authentication, various well-known authentication methods may be used, and in particular, in an order to block remittance to an account wrongfully used for crime such as a fake deposit, effective methods such as fingerprint or facial image authentication, checking information on whether a medical insurance premium is paid, checking a report of disappearance through a national police agency server, or the like may be used.

In a state in which registration of authentication information in the sub-authentication processing server 8 is completed, any one main authenticator generates, to the financial server 6, authentication information and a signal for requesting financial processing such as remittance or transfer.

The financial processing request signal includes information on remittance to a specific sub-authenticator. In this case, the remittance process further includes a step in which a remittance amount is transferred to and on standby in a recipient temporary account by the sub-authentication processing server 8. That is, even when the authentication of the main authenticator is completed, if the authentication of the sub-authenticator is not completed, the sub-authentication processing server 8 performs processing so that the remittance amount is not remitted, but is on standby in the recipient temporary account.

That is, in a state in which the authentication of the main authenticator is completed, the financial server 6 transmits sub-authenticator information to the sub-authentication processing server 8 using the sub-authenticator information, for example, recipient information.

Then, the sub-authentication processing server 8 transmits an authentication request signal to the sub-authenticator terminal 2B. Once the authentication request signal is received, the financial information processing application 4 may be activated to receive the authentication information.

When the financial information processing application 4 is activated, an authentication screen 22 illustrated in FIG. 3 is output, and remittance history and authentication request information 24 is output on the authentication screen 22.

The remittance history and authentication request information 24 indicating, for example, “100,000 won have been transferred to your temporary account. Please perform sub-authentication (recipient authentication).” is output on the screen.

Thereby, the sub-authenticator may recognize that the remittance amount can be transferred or withdrawn only when the sub-authentication is performed. An authentication button 26 is provided below the remittance history and authentication request information 24.

In this state, if the sub-authenticator inputs the authentication information, the sub-authenticator terminal 2B transmits the authentication information to the sub-authentication processing server 8.

Then, the sub-authentication processing server 8 performs the authentication processing.

At this time, the authentication processing may be a step of determining whether the recipient is a recipient pre-registered in the sub-authentication processing server 8, and may be authentication processing performed by an external institution, in which the sub-authenticator information is transmitted to an e-government server, a national police agency server, or a national health insurance service server to perform the authentication processing.

Next, the sub-authentication processing server 8 transmits authentication result information to the financial server 6. When the authentication succeeds, the financial server 6 performs financial processing (e.g., remittance) requested by the main authenticator.

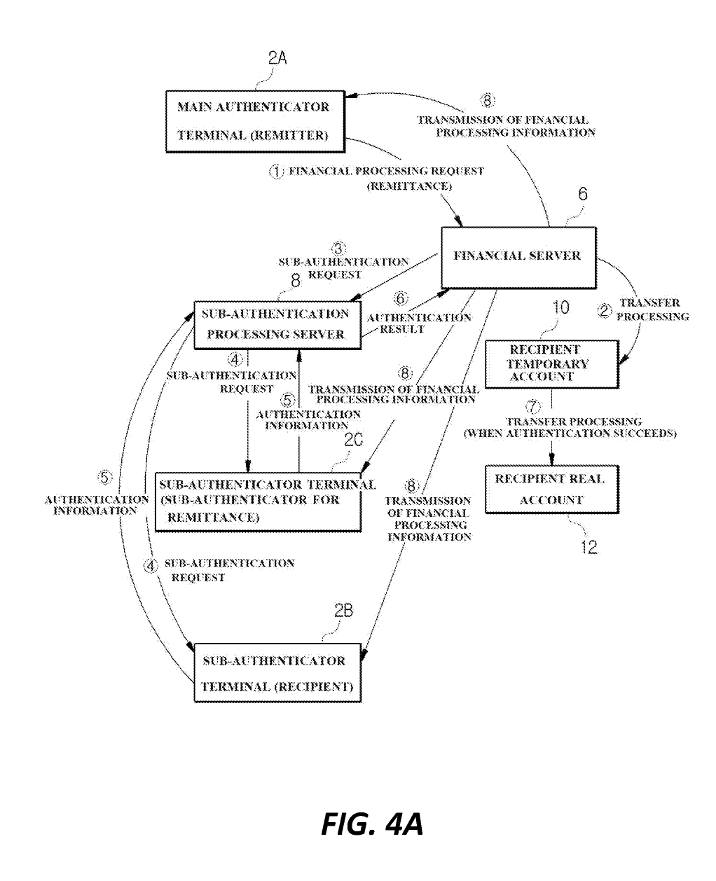

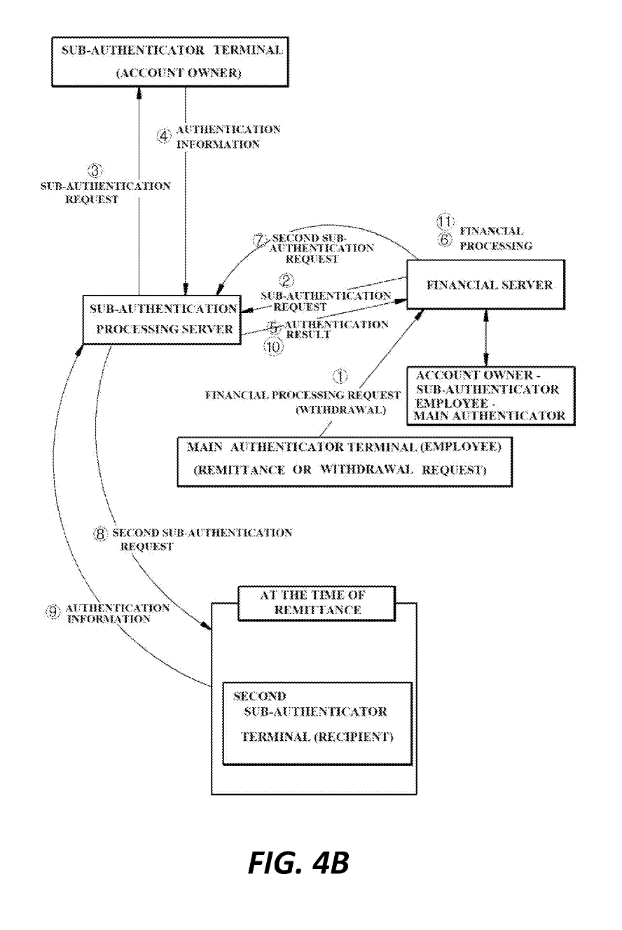

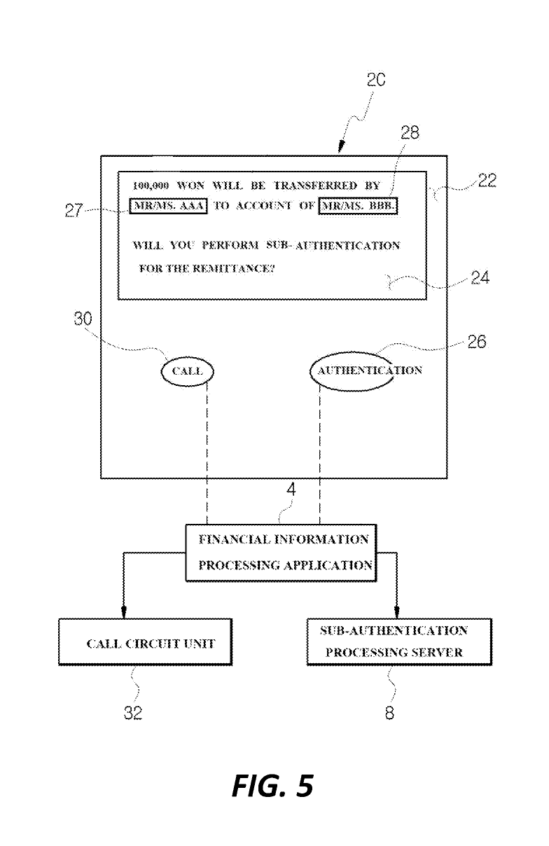

FIG. 4A is a diagram illustrating a state of processing a plurality of sub-authentications through the customized financial processing system using sub-authentication according to the first embodiment of the present invention, and FIG. 5 is a diagram illustrating an additionally designated sub-authentication screen in a remittance step through the customized financial processing system using sub-authentication according to the first embodiment of the present invention.

Referring to FIGS. 4A and 5, in the customized financial processing system using sub-authentication according to the first embodiment of the present invention, when a plurality of sub-authentications are performed by registering a plurality of sub-authenticators, remittance may be made to the real account of the recipient.

That is, in an order to prevent voice phishing, children or an acquaintance may be registered as a sub-authenticator for remittance.

Even if the main authenticator for remittance wants to perform the remittance after the authentication process, the remittance is actually made only when additional authentication of the sub-authenticator for remittance is completed. In this case, if the children or acquaintance is set as the additional sub-authenticator for remittance, a possibility that parents suffer from voice phishing is lowered.

The reason is that the children or acquaintance may be more objective than the main authenticator who is a subject of the remittance.

Therefore, the main authenticator may be an account owner, and the sub-authenticator may be both the main authenticator' acquaintance who is connected together with the main acquaintance when requesting remittance of the main authenticator, and the recipient.

That is, the sub-authenticator is divided into a first sub-authenticator connected together with the main authenticator when requesting remittance of the main authenticator, and a second sub-authenticator who is a recipient for receiving a remittance amount from the main authenticator, and the remittance processing is performed when the authentications of the first and second sub-authenticators succeed.

The customized financial processing system using sub-authentication according to the first embodiment of the present invention configured as described above performs a step in which the sub-authenticator registers his/her authentication information in the sub-authentication processing server 8 as illustrated in FIGS. 4A and 5. The plurality of sub-authenticators, for example, the sub-authenticators are divided into the first sub-authenticator connected together with the main authenticator when requesting remittance of the main authenticator, and the second sub-authenticator who is a recipient for receiving a remittance amount from the main authenticator, which are registered in the sub-authentication processing server 8.

In a state in which registration of authentication information in the sub-authentication processing server 8 is completed, any one main authenticator generates, to the financial server 6, authentication information and a signal for requesting financial processing such as remittance or transfer. The financial processing request signal includes information on remittance to a specific sub-authenticator.

In this case, the remittance process further includes a step in which a remittance amount is transferred to and on standby in a recipient temporary account by the sub-authentication processing server 8. That is, even when the authentication of the main authenticator is completed, if the authentication of the sub-authenticator is not completed, the sub-authentication processing server 8 performs processing so that the remittance amount is not remitted, but is on standby in the recipient temporary account.

That is, in a state in which the authentication of the main authenticator is completed, the financial server 6 transmits sub-authenticator information to the sub-authentication processing server 8 using the sub-authenticator information, for example, recipient information.

At this time, the financial server 6 extracts sub-authenticator information for requesting an approval signal for remittance to the recipient to the sub-authenticator connected to the main authenticator. That is, the sub-authenticator corresponds to both the first sub-authenticator connected to the main authenticator and the second sub-authenticator who is the recipient correspond to the sub-authenticator.

Then, the sub-authentication processing server 8 transmits an authentication request signal to the sub-authenticator terminal 2B. Once the authentication request signal is received, the financial information processing application 4 may be activated to receive the authentication information.

At this time, if the financial processing request signal is for remittance, and the sub-authenticator information extracted by the financial server 6 is information of an acquaintance of the main authenticator, the approval signal of the acquaintance for the remittance is requested, and the sub-authentication processing of the recipient who is an object of the remittance is requested to the sub-authentication processing server 8.

Next, when the financial information processing application 4 is activated, an authentication screen 22 illustrated in FIG. 5 is output, and remittance history and authentication request information 24 is output on the authentication screen 22.

The remittance history and authentication request information 24 indicating, for example, “100,000 won will be transferred by Mr/Ms. ∘∘∘ 27 (main authenticator) to an account of Mr/Ms. ×××28 (second sub-authenticator). Will you perform sub-authentication for the remittance?” is output on the screen.

A call button 30 and an authentication button 26 are provided below the remittance history and authentication request information 24.

At this time, since the call button 30 is hyperlinked to a phone number of the main authenticator terminal 2A, when clicking the call button 30, the first sub-authenticator may rapidly share information on remittance that is on standby by calling the main authenticator before the remittance is made.

In this state, when the first sub-authenticator inputs the authentication information, the first sub-authenticator terminal 2C transmits the authentication information to the sub-authentication processing server 8.

Then, the sub-authentication processing server 8 performs the authentication processing.

Thereby, the first sub-authentication is completed only when the first sub-authenticator performs the sub-authentication. The first sub-authentication generates both of signals for remittance approval and authentication.

When the first sub-authentication is performed, the sub-authentication processing server 8 outputs a remittance message as illustrated in FIG. 3 to the second sub-authenticator terminal 2B (recipient terminal). The second sub-authenticator may recognize that the remittance amount can be transferred or withdrawn only when the authentication of the second sub-authenticator is performed for the remittance.

At this time, the authentication processing is a step of determining whether the recipient is a recipient pre-registered in the sub-authentication processing server 8, and various well-known authentication methods may be used.

Next, the sub-authentication processing server 8 transmits authentication result information to the financial server 6. When the authentication succeeds, the financial server 6 performs financial processing (e.g., remittance) requested by the main authenticator.

Meanwhile, the first and second sub-authenticators may set pre-authentication in the financial information processing application 4 installed in their terminal in advance, and may also perform post-authentication while checking authentication request information for the financial processing later.

In the case of the pre-authentication, the first and second sub-authenticators set an approval signal for the sub-authentication processing server 8 in advance. In this case, the sub-authenticator inputs information on the main authenticator, and sets the pre-authentication while inputting a remittance amount in advance.

To this end, for the pre-authentication, the first and second sub-authenticators need to know when the remittance is made and how much the amount is remitted through calling the main authenticator. As the authentication method, various authentication methods such as scanning fingerprints or photographing a facial image and transmitting the scanned fingerprints or the photographed facial image to the sub-authentication processing server 8 are used as they are.

The post-authentication may be used when the sub-authentication is not performed since the sub-authenticator is in an away status in which the sub-authenticator may not check the terminal. In this case, the remittance amount that is on standby in the temporary account is remitted at the time of completing the sub-authentication.

FIG. 4B is a diagram illustrating a state of processing sub-authentication that is limitedly performed for a withdrawal through the customized financial processing system using sub-authentication according to the first embodiment of the present invention.

Referring to FIG. 4B, in the customized financial processing system using sub-authentication according to the first embodiment of the present invention, an accounting clerk or a money manager in a company manages an account of the company. In the case of depositing funds to the account of the company, since the accounting clerk or the money manager serves to perform the second sub-authentication which is the recipient authentication, the accounting clerk or the money manager may perform the authentication alone, but in the case of transferring money to an external account or withdrawing cash from the account of the company, there is a limitation that the authentication of the first sub-authenticator who is the account owner needs to be essentially performed.

That is, in a case in which the money manager is set as the main authenticator, the sub-authentication processing server 8 allows receipt confirmation to be performed only by the authentication of the main authenticator, and limits the remittance or the withdrawal to be performed only when the authentication of the sub-authenticator who is the account owner additionally succeeds.

Therefore, in the customized financial processing system using sub-authentication according to the first embodiment of the present invention, money deposited into the account of the company may be deposited by processing the recipient authentication by the money manager or the accounting clerk alone without performing the authentication by the account owner, and in the case of the transfer or the withdrawal to an external account, the authentication of the account owner needs to be essentially performed, such that an employee may not illegally withdraw money alone.

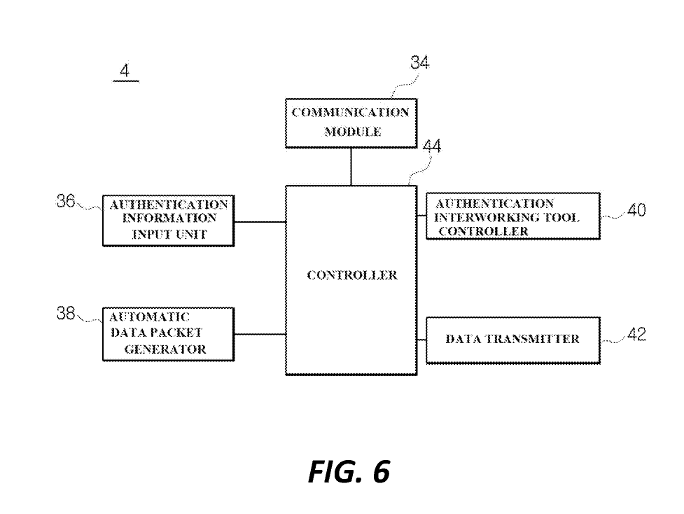

FIG. 6 is a block diagram illustrating a configuration of a financial information processing application included in the customized financial processing system using sub-authentication according to the first embodiment of the present invention and installed in an authenticator terminal.

Referring to FIG. 6, the financial information processing application 4 included in the customized financial processing system using sub-authentication according to the first embodiment of the present invention and installed in the authenticator terminals 2A and 2B includes an authentication information input unit 36 configured to input information such as a password, a pattern image, an authenticated certificate, or a mobile phone authentication number, or input authentication information such as a fingerprint image or a facial image; and an authentication interworking tool controller 40 configured to control an operation of an authentication interworking tool including a fingerprint sensor for scanning fingerprints or a camera for photographing an image of the sub-authenticator.

Further, the financial information processing application 4 may include an automatic data packet generator 38 configured to generate a single data packet including authentication information, an application identification number, and terminal identification information; a data transmitter 42 configured to automatically transmit the data packet generated in the automatic data packet generator 38 to the sub-authentication processing server 8; and a controller 44 configured to receive sub-authentication request information from the sub-authentication processing server 8, and perform a control to input and transmit sub-authentication information.

The inventive system Further includes a communication module 34 that performs communication for the sub-authentication processing server 8.

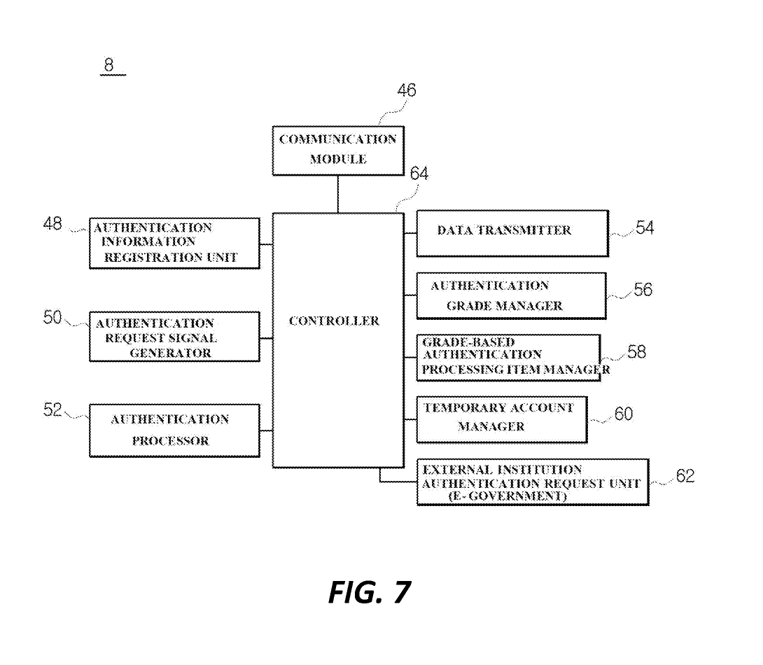

FIG. 7 is a block diagram illustrating a configuration of a sub-authentication processing server included in the customized financial processing system using sub-authentication according to the first embodiment of the present invention.

Referring to FIG. 7, the sub-authentication processing server 8 included in the customized financial processing system using sub-authentication according to the first embodiment of the present invention includes an authentication information registration unit 48 configured to register authentication information of the sub-authenticator; an authentication request signal generator 50 configured to generate an authentication request signal to the sub-authenticator terminal 2B; an authentication processor 52 configured to compare authentication information pre-registered in the authentication information registration unit 48 with authentication information transmitted from the sub-authenticator terminal 2B to perform authentication processing; and a data transmitter 54 configured to transmit results of the authentication processed in the authentication processor 52 to the financial server 6.

Further, the sub-authentication processing server 8 further includes a controller 64 configured to receive an authentication request signal for a specific sub-authenticator from the financial server 6 and perform a control to perform authentication processing for the sub-authenticator; a temporary account manager 60 in which a remittance amount to be remitted to the recipient at the time of completing the authentication of the main authenticator is on standby; and an external institution authentication request unit 62 configured to transmit sub-authenticator information to an e-government server, a national police agency server, or a national health insurance service server to perform authentication processing.

Meanwhile, in the customized financial processing system using sub-authentication according to the first embodiment of the present invention, a grade based on account establishment information and use information of the recipient is assigned in advance, such that the authentication is performed through different authentication items for each grade. The sub-authentication processing server 8 plays a leading role in the grade management and the authentication processing.

Accordingly, the sub-authentication processing server further includes an authentication grade manager 56 configured to assign and manage a recipient grade based on establishment and a state of the recipient account; and a grade-based authentication processing item manager 58 configured to manage authentication processing items for each recipient grade. The inventive system further includes a communication module 46 performing communication for the authenticator terminals.

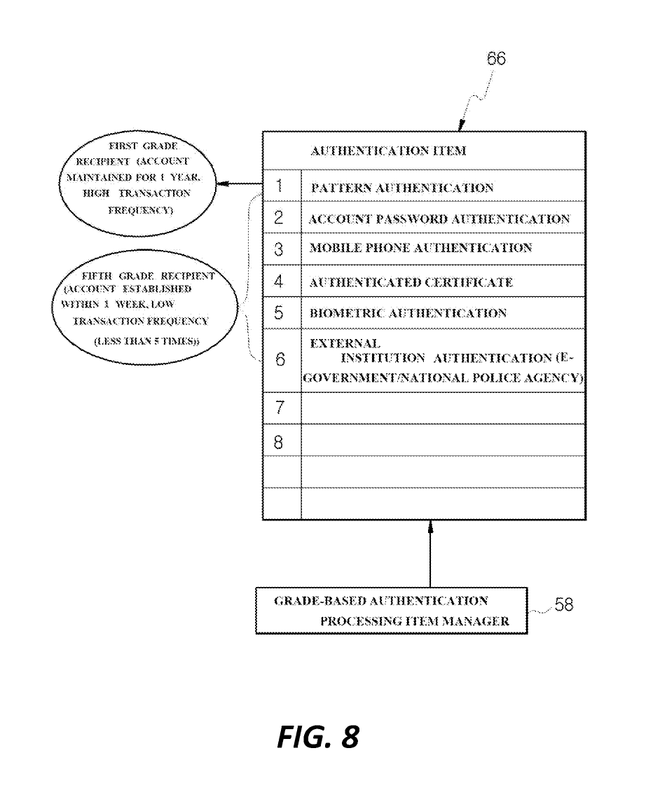

FIG. 8 is an authentication item table illustrating authentication items for each grade through the customized financial processing system using sub-authentication according to the first embodiment of the present invention.

Herein, the authentication for each grade will be described in more detail with reference to FIG. 8. The customized financial processing system using sub-authentication according to the first embodiment of the present invention is a system in which a grade based on account establishment information and use information of a recipient is assigned in advance, such that authentication is performed through different authentication items for each grade, thereby making complex additional authentication to be performed for an account with a low grade that is probably a fake deposit.

That is, the sub-authentication processing server 8 assigns a recipient grade based on the establishment and a state of the recipient account, and makes different authentication processes to be performed for each recipient grade.

The sub-authentication processing server 8 has an authentication item table 66 constructed therein, which includes authentication items to be processed for each recipient grade assigned in advance based on the establishment and the state of the recipient account.

The sub-authentication processing server 8 is configured to assign a grade in an order from the oldest recipient account establishment date and in an order from the highest transaction frequency.

Further, the authentication item table 66 includes pre-registered authentication items according to a grade of the sub-authenticator among items classified in an order of mobile phone pattern authentication; account password authentication; authentication through a mobile phone authentication number; authentication through an authenticated certificate; biometric authentication through fingerprints, irises, genes, and facial recognition; and external institution authentication through an e-government, a national police agency, or a national health insurance service.

For example, there is a difference in an authentication item that needs to be essentially processed depending on the grade assigned according to a recipient account establishment date (a low grade is assigned if it is recently established), a transaction period, a transaction frequency, an accumulated transaction amount, financial credit information, whether mobile phone authentication is made, or the like in advance. For example, for a first grade, remittance can be confirmed simply by inputting a password or a pattern, and for a fifth grade, complex additional sub-authentication such as fingerprint authentication, mobile phone authentication, and authenticated certificate authentication is performed, and remittance is completed after passing through the authentication, thereby ultimately eradicating fake deposits.

At this time, the sub-authentication processing server 8 may perform setting so that the remittance limitation is not applied in an exceptional case that the remitter transfers money to his/her another account in another bank.

Further, in a case in which a significantly large amount of money more than a predetermined amount is transferred to an account of a recipient recently established and of which a transaction frequency is very low after passing through all authentications, transfer or withdrawal may be limited until additional authentication (for example, a call with a bank clerk, and the like).

Meanwhile, systematic selection for a grade is automatically made according to a transaction frequency between both parties, and the remitter may also select a grade authentication of a recipient according to an individual setting.

That is, in a case of very importance client that is recently connected, although the financial transaction frequency is low, the main authenticator may selectively raise the grade at the time of financial transaction with the client.

Further, if the remitter and the recipient in a relationship such as close acquaintances, for example, a family, a friend, a relative, or a senior or junior, or if frequency of transaction therebetween is very high, the recipient authentication may be automatically minimally performed, or a recipient personal information may be transmitted to the remitter.

That is, if the remitter and the recipient in a relationship such as close acquaintances, for example, a family, a friend, a relative, or a senior or junior, or if frequency of transaction therebetween is very high, the financial information processing application 4 installed in the sub-authenticator terminal 2B that is the recipient may automatically operate a camera, and transmit an image of the recipient to the main authenticator terminal 2A.

Therefore, a step of assigning, by the sub-authentication processing server 8, a grade of the sub-authenticator; and a step of performing, by the sub-authentication processing server 8, authentication on the authentication item matched with each grade of the sub-authenticator are further included.

Hereinafter, a second embodiment of the present invention will be described in detail with reference to the drawings.

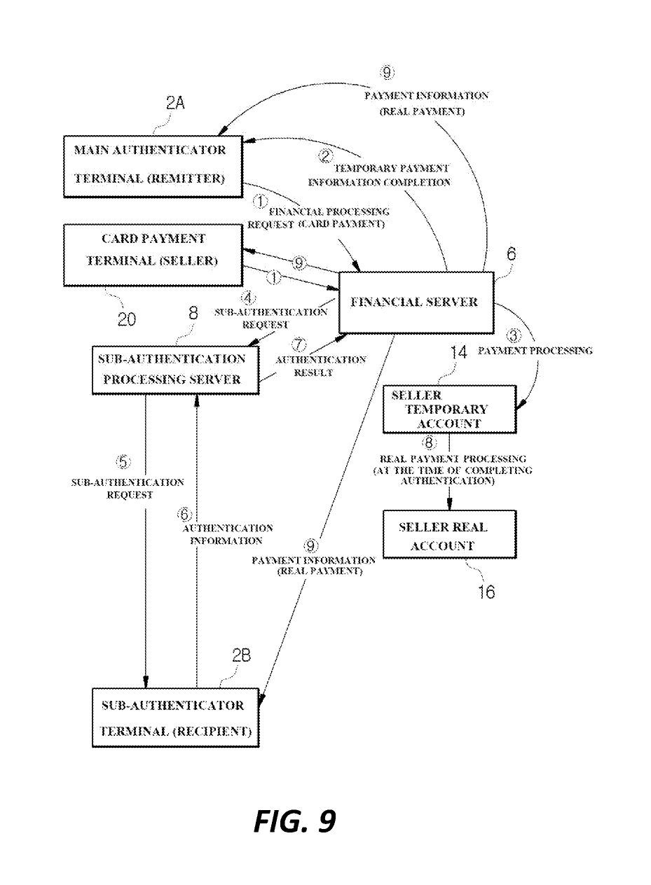

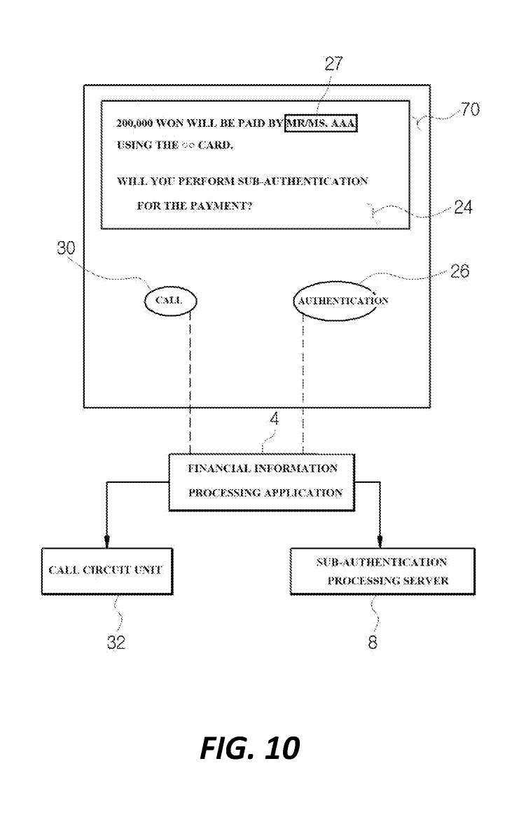

FIG. 9 is a flow chart illustrating that sub-authentication is performed at the time of payment through a customized financial processing system using sub-authentication according to a second embodiment of the present invention, and FIG. 10 is a diagram illustrating a screen displayed on a sub-authenticator terminal through the customized financial processing system using sub-authentication according to the second embodiment of the present invention.

Referring to FIGS. 9 and 10, the customized financial processing system using sub-authentication according to the second embodiment of the present invention is a system in which payment is made after seller authentication and approval of an additionally registered acquaintance in a case of card payment, such that safe credit transaction can be made.

More specifically, the customized financial processing system using sub-authentication according to the second embodiment of the present invention is a system in which payment is made when sub-authentication is performed, at the time of attempting payment for a product using a credit card or a debit card.

This induces normal use of a card by performing sub-authentication of an acquaintance connected to the main authenticator, for example, a spouse or children, for the payment action of the main authenticator attempting the payment.

Further, seller authentication may also be additionally performed.

More specifically, when authentication is requested by a financial server 6 receiving a signal for requesting payment of a predetermined amount to a credit card account or a debit card account of the main authenticator from a main authenticator terminal 2A, a sub-authentication processing server 8 included in the customized financial processing system using sub-authentication according to the second embodiment of the present invention is configured to transmit payment information to a pre-registered sub-authenticator terminal 2B, and request authentication information for approving the card payment, and the financial server 6 is configured to make payment information to be on standby in a temporary account 14 of the seller until the authentication is completed.

Further, in the sub-authenticator terminal 2B receiving a request for a payment approval signal from the sub-authentication processing server 8, temporary payment information and a call button 30 for a call with the main authenticator is further output on a screen of the financial information processing application 4.

The customized financial processing system using sub-authentication according to the second embodiment of the present invention configured as described above may perform a step in which the sub-authenticator registers his/her authentication information in the sub-authentication processing server 8 as illustrated in FIGS. 9 and 10, thus to perform a plurality of sub-authentications including the seller.

For example, the sub-authenticator is divided into a first sub-authenticator connected together with the main authenticator when attempting payment of the main authenticator, and a second sub-authenticator who is a seller for receiving a payment amount from the main authenticator, which are registered in the sub-authentication processing server 8. The first sub-authenticator may also limit a type of business that the payment may be made in the sub-authentication processing server 8 so that payment for a product of an illegal company such as a pyramid sales company is not made through the authentication of the seller.

In a state in which registration of authentication information in the sub-authentication processing server 8 is completed, any one main authenticator generates, to the financial server 6, authentication information and a payment request signal through on-line payment for a product using a card payment terminal 20 in an affiliate store or the main authenticator terminal 2A.

At this time, the financial server 6 is a server of a credit card company.

In the case in which the main authenticator attempts card payment, a step in which a payment amount is on standby in a seller temporary account by the sub-authentication processing server 8 is further included. That is, even when the authentication of the main authenticator is completed, if the authentication of the first and second sub-authenticators is not completed, the sub-authentication processing server 8 performs processing so that the payment amount is not paid, but is on standby in the seller temporary account.

That is, in a state in which the authentication of the main authenticator is completed, the financial server 6 transmits sub-authenticator information to the sub-authentication processing server 8 using information of the sub-authenticator, for example, the first sub-authenticator who is an acquaintance of the main authenticator connected to the main authenticator and the second sub-authenticator who is the seller.

At this time, the financial server 6 extracts sub-authenticator information for requesting an approval signal for card payment for a product of the seller to the sub-authenticator connected to the main authenticator. That is, the sub-authenticator corresponds to both the first sub-authenticator connected to the main authenticator and the second sub-authenticator who is the seller correspond to the sub-authenticator.

Then, the sub-authentication processing server 8 transmits an authentication request signal to the sub-authenticator terminal 2B. Once the authentication request signal is received, the financial information processing application 4 may be activated to receive the authentication information.

At this time, the financial server 6 requests an approval signal of the acquaintance for the payment of the main authenticator, and requests the sub-authentication processing of the product seller to the sub-authentication processing server 8.

Next, when the financial information processing application 4 is activated, an authentication screen 70 illustrated in FIG. 10 is output. Payment history and authentication request information 24 is output on the authentication screen 70.

The payment history and authentication request information 24 indicating, for example, “200,000 won will be paid by Mr/Ms. ∘∘∘ 27 (main authenticator) using the ∘∘ card. Will you perform sub-authentication for the payment?” is output on the screen.

A call button 30 and an authentication button 26 are provided below the payment history and authentication request information 24.

At this time, since the call button 30 is hyperlinked to a phone number of the main authenticator terminal 2A, when clicking the call button 30, the first sub-authenticator may rapidly share information on payment that is on standby by calling the main authenticator before the payment is actually made.

In this state, when the first sub-authenticator inputs the authentication information, the first sub-authenticator terminal transmits the authentication information to the sub-authentication processing server 8.

Then, the sub-authentication processing server 8 performs the authentication processing.

Thereby, the first sub-authentication is completed only when the first sub-authenticator performs the sub-authentication. The first sub-authentication generates both of signals for payment approval and authentication.

When the first sub-authentication is performed, the sub-authentication processing server 8 outputs a payment standby message to the second sub-authenticator terminal 2B (seller terminal). The second sub-authenticator may recognize that the payment is completed and the sale is completed only when the authentication of the second sub-authenticator is performed for the payment.

At this time, the authentication processing is a step of determining whether the seller is a seller pre-registered in the sub-authentication processing server 8, and various well-known authentication methods may be used.

Next, the sub-authentication processing server 8 transmits authentication result information to the financial server 6. When the authentication succeeds, the financial server 6 performs financial processing (e.g., credit payment or debit payment) requested by the main authenticator.

Meanwhile, the customized financial processing system and the method using sub-authentication according to the embodiment of the present invention is not limited to above described embodiment, but may be variously modified without departing from the technical gist of the present invention.

### DESCRIPTION OF REFERENCE NUMERALS

2A: Main authenticator terminal
2B: Sub-authenticator terminal
4: Financial information processing application
6: Financial server
8: Sub-authentication processing server
20: Card payment terminal

1.-38. (canceled)

39. A customized financial processing method using sub-authentication, comprising:
a) receiving, by a sub-authentication processing server, authentication information from a sub-authenticator terminal and registering the authentication information;
b) receiving, by a financial server, authentication information and a financial processing request signal from a main authenticator terminal;
c) performing, by the financial server, transfer from an account of a main authenticator to a temporary account of a sub-authenticator;
d) transmitting, by the financial server, the sub-authentication information to the sub-authentication processing server;
e) transmitting, by the sub-authentication processing server, an authentication request signal to the sub-authenticator terminal;
f) receiving, by the sub-authentication terminal, authentication information that is applied;
g) transmitting, by the sub-authenticator terminal, the authentication information to the sub-authentication processing server;
h) performing, by the sub-authentication processing server, authentication processing;
i) transmitting, by the sub-authentication processing server, authentication result information to the financial server; and
j) performing, by the financial server, financial processing from the temporary account of the sub-authenticator to a real account.

40. The customized financial processing method of claim 39, further comprising: between the receiving b) and the transmitting d),
transferring, by the sub-authentication processing server, a remittance amount to a recipient temporary account and making the remittance amount to be on standby, in a case of remittance.

41. The customized financial processing method of claim 39, further comprising: before the performing h), assigning, by the sub-authentication processing server, a grade of the sub-authenticator; and
in the performing h), performing, by the sub-authentication processing server, the authentication for an authentication item matched with each grade of the sub-authenticator.

42. A customized financial processing system using sub-authentication, comprising:
a main authenticator terminal configured to generate, to a financial server, a signal for requesting a financial account of a main authenticator to perform transfer or payment of a certain amount of money, receive information on a sub-authentication processing state in response to the request signal, and output the information on a screen;
a sub-authenticator terminal in which a financial information processing application for inputting sub-authentication information by receiving a sub-authentication request signal from a sub-authentication processing server in response to the signal for requesting the financial account of the main authenticator to perform transfer or payment of the certain amount of money is installed;
the financial server configured to pre-register authentication information of the main authenticator, determine whether sub-authentication is normally processed by interworking with the sub-authentication processing server when a request signal for a specific financial processing is received from the main authenticator terminal, and perform the financial processing requested by the main authenticator; and
the sub-authentication processing server configured to pre-register authentication information of the sub-authenticator, transmit the sub-authentication request signal to the sub-authenticator terminal when receiving the sub-authentication request signal from the financial server, perform sub-authentication processing in response to the sub-authentication request signal, and transmit information on a result of the sub-authentication processing to the financial server,
wherein the sub-authentication processing server comprises a database including information of a recipient temporary account constructed therein, in which a remittance amount to be remitted to a recipient is on standby until authentication of the main authenticator is completed, and
the sub-authentication processing server 8 further includes an external institution authentication request unit configured to transmit sub-authenticator information to an electronic government (e-government) server, a national police agency server, or a national health insurance service server to perform authentication processing.

43. The customized financial processing system of claim 42, wherein the main authenticator is an account owner.

44. The customized financial processing system of claim 42, wherein the sub-authenticator is a recipient.

45. The customized financial processing system of claim 42, wherein the financial server comprises a database including the recipient temporary account in which the remittance amount to be remitted to the recipient at the time of completing the authentication of the main authenticator is on standby, and
a recipient real account to which the remittance amount to be remitted to the recipient at the time of completing the authentication of the sub-authenticator is remitted, which are dividedly constructed therein.

46. The customized financial processing system of claim 42, wherein the sub-authentication processing server is constructed in the financial server while being separately divided.

47. The customized financial processing system of claim 42, wherein the financial information processing application installed in the sub-authenticator terminal interworks with an authentication tool configured to operate a fingerprint sensor for scanning fingerprints or a camera for photographing an image of the sub-authenticator.

48. The customized financial processing system of claim 42, wherein the sub-authentication processing server performs sub-authentication by interworking with the e-government server in which a fingerprint image or a facial image of the sub-authenticator is pre-registered.

49. The customized financial processing system of claim 42, wherein the financial information processing application comprises:
an authentication information input unit configured to input information such as a password, a pattern image, an authenticated certificate, or a mobile phone authentication number, or input authentication information such as a fingerprint image or a facial image;
an authentication interworking tool controller configured to control an operation of an authentication interworking tool including a fingerprint sensor for scanning fingerprints or a camera for photographing an image of the sub-authenticator;
an automatic data packet generator configured to generate a single data packet including authentication information, an application identification number, and terminal identification information;
a data transmitter configured to automatically transmit the data packet generated in the automatic data packet generator to the sub-authentication processing server; and
a controller configured to receive sub-authentication request information from the sub-authentication processing server, and perform a control to input and transmit sub-authentication information.

50. The customized financial processing system of claim 42, wherein the sub-authentication processing server further comprises:
an authentication information registration unit configured to register authentication information of the sub-authenticator;
an authentication request signal generator configured to generate the authentication request signal to the sub-authenticator terminal;
an authentication processor configured to compare the authentication information pre-registered in the authentication information registration unit with authentication information transmitted from the sub-authenticator terminal to perform authentication processing;
a data transmitter configured to transmit results of the authentication processed in the authentication processor to the financial server; and
a controller configured to receive an authentication request signal for a specific sub-authenticator from the financial server and perform a control to perform authentication processing for the sub-authenticator.

51. The customized financial processing system of claim 42, wherein the sub-authentication processing server further comprises a temporary account manager in which a remittance amount to be remitted to the recipient at the time of completing the authentication of the main authenticator is on standby.

52. The customized financial processing system of claim 42, wherein the sub-authenticator is divided into a first sub-authenticator connected together with the main authenticator when requesting remittance of the main authenticator, and a second sub-authenticator who is a recipient for receiving a remittance amount from the main authenticator, and remittance processing is performed when authentications of the first and second sub-authenticators succeed.

53. The customized financial processing system of claim 42, wherein in a case in which a money manager is set as the main authenticator, the sub-authentication processing server allows receipt confirmation to be performed only by the authentication of the main authenticator, and limits remittance or withdrawal to be performed only when authentication of the sub-authenticator who is an account owner additionally succeeds.

54. The customized financial processing system of claim 42, wherein the sub-authentication processing server assigns a recipient grade based on establishment and a state of a recipient account, and makes different authentication processes to be performed for each recipient grade.

55. The customized financial processing system of claim 42, wherein the sub-authentication processing server further comprises:
an authentication grade manager configured to assign and manage a recipient grade based on establishment and a state of a recipient account; and
a grade-based authentication processing item manager configured to manage authentication processing items for each recipient grade.

56. The customized financial processing system of claim 42, wherein the sub-authentication processing server comprises an authentication item table constructed therein, which includes authentication items to be processed for each recipient grade assigned in advance based on establishment and a state of a recipient account.

57. The customized financial processing system of claim 42, wherein when authentication is requested by the financial server receiving a signal for requesting payment of a predetermined amount to a credit card account or a debit card account of the main authenticator from the main authenticator terminal,
the sub-authentication processing server is configured to transmit payment information to a pre-registered sub-authenticator terminal, and request authentication information for approving the card payment, and
the financial server is configured to make the payment information to be on standby in a temporary account of a seller until the authentication is completed.

58. The customized financial processing system of claim 56, wherein the authentication item table includes pre-registered authentication items according to a grade of the sub-authenticator among items classified in an order of mobile phone pattern authentication; account password authentication; authentication through a mobile phone authentication number; authentication through an authenticated certificate; biometric authentication through fingerprints, irises, genes, and facial recognition; and external institution authentication through an e-government, a national police agency, or a national health insurance service.
